(19) United States
(12) Patent Application Publication
(10) Pub. No.: US 2026/0079821 A1
(43) Pub. Date: Mar. 19, 2026

(54) METHOD, APPARATUS, DEVICE, MEDIUM AND PROGRAM PRODUCT FOR TESTING APPLICATION

(71) Applicant: Beijing Zitiao Network Technology Co., Ltd., Beijing (CN)

(72) Inventor: Yanwen JU, Beijing (CN)

(21) Appl. No.: 19/327,870

(22) Filed: Sep. 12, 2025

(30) Foreign Application Priority Data
Sep. 14, 2024 (WO) PCT/CN2024/119179

(51) Int. Cl. G06F 11/3668

(52) U.S. Cl. CPC G06F 11/3684; G06F 11/3688

(57) ABSTRACT

Embodiments of the present disclosure provide a method, apparatus, a device, a medium and a program product for testing applications. The method comprises sending to a server a first state of an application running on a terminal, the first state being a state related to an interface of the application. The method also comprises receiving a target conversion command from the server based on sending of the first state, the target conversion command being determined based on a state conversion digraph for the application and the state conversion digraph including a set of states related to an interface of the application and a set of operation sequences for implementing state conversion. The method further comprises generating, based on the first state and the target conversion command, a second state of the application to implement test of the application.

### CROSS-REFERENCE TO RELATED APPLICATION(S)

This application claims priority to PCT Application No. PCT/CN2024/119179 filed Sep. 14, 2024, the disclosure of which is incorporated herein by reference in its entity.

### FIELD

Embodiments of the present disclosure generally relate to the field of application development, and more specifically; to a method, an apparatus, a device, a medium and a program product for testing applications.

### BACKGROUND

At present, technology for application test is receiving more attention from development staff. The current common software development mode usually depends on related technical documents, which technical documents are often drafted on the basis of texts and contain strong technical and logic contents. The development staff develop the software by reading the related technical documents.

With advance in technology for application test, the drafting manner of the technical documents the content arrangement of the documents before the start of the development have been optimized several times. Due to the constant optimization, readability and logicality of the technical documents have been greatly improved, such that the front-end and back-end development staff and the test staff can take better advantage of the technical documents during the development to accelerate the application development.

### SUMMARY

Embodiments of the present disclosure provide a method, apparatus, a device, a medium and a program product for testing applications.

In accordance with a first aspect of the present disclosure, there is provided a method for testing applications. The method comprises sending to a server a first state of an application running on a terminal, the first state being a state related to an interface of the application. The method also comprises receiving from the server a target conversion command based on sending of the first state, the target conversion command being determined based on a state conversion digraph for the application and the state conversion digraph including a set of states related to an interface of the application and a set of operation sequences for implementing state conversion. The method further comprises generating, based on the first state and the target conversion command, a second state of the application to implement test of the application.

In accordance with a second aspect of the present disclosure, there is provided a method for testing applications. The apparatus comprises determining a target execution sequence related to a state conversion digraph, the state conversion digraph including a set of states related to an interface of an application and a set of operation sequences for implementing state conversion. The method also comprises receiving a first state from a terminal, the first state being a state related to an interface of the application running on the terminal. The method further comprises determining, based on the first state and the target execution sequence, a target conversion command for converting the first state to a second state. The method also comprises sending to the terminal the target conversion command to implement test of the application.

In accordance with a third aspect of the present disclosure, there is provided an apparatus for testing applications. The apparatus comprises a first state sending module, configured to send to a server a first state of an application running on a terminal, the first state being a state related to an interface of the application; a target conversion command receiving module, configured to receive from the server a target conversion command based on sending of the first state, the target conversion command being determined based on a state conversion digraph for the application and the state conversion digraph including a set of states related to an interface of the application and a set of operation sequences for implementing state conversion; and a second state generating module, configured to generate, based on the first state and the target conversion command, a second state of the application to implement test of the application.

In accordance with a fourth aspect of the present disclosure, there is provided an apparatus for testing applications. The apparatus comprises a target execution sequence determining module, configured to determine a target execution sequence related to a state conversion digraph, the state conversion digraph including a set of states related to an interface of an application and a set of operation sequences for implementing state conversion; a first state receiving module, configured to receive a first state from a terminal, the first state being a state related to an interface of the application running on the terminal; a target conversion command determining module, configured to determine, based on the first state and the target execution sequence, a target conversion command for converting the first state to a second state; and a target conversion command sending module, configured to send to the terminal the target conversion command to implement test of the application.

In accordance with a fifth aspect of the present disclosure, there is provided an electronic device, comprising at least one processor; and a memory for storing at least one program, the at least one program, when executed by the at least one processor, causing the at least one processor to implement the method according to the first aspect and the second aspect of the present disclosure.

In accordance with a sixth aspect of the present disclosure, there is provided a computer-readable storage medium stored thereon with computer programs, the computer programs, when executed by a processor, implementing the method according to the first aspect and the second aspect of the present disclosure.

In accordance with a seventh aspect of the present disclosure, there is provided a computer program product. The computer program product includes computer programs, the computer programs, when executed by a processor, implementing the method according to the first aspect and the second aspect of the present disclosure.

It should be appreciated that the contents described in this Summary are not intended to identify key or essential features of the embodiments of the present disclosure, or limit the scope of the present disclosure. Other features of the present disclosure will be understood more easily through the following description.

### BRIEF DESCRIPTION OF THE DRAWINGS

Through the following detailed description of the example embodiments of the present disclosure with reference to the accompanying drawings, the above and other objectives, features, and advantages of the present disclosure will become more apparent. In the example embodiments of the present disclosure, the same reference sign usually indicates the same component.

FIG. 1 illustrates a schematic diagram of an example environment in which the device and/or method according to some embodiments of the present disclosure may be implemented;

FIG. 2 illustrates a schematic diagram of an example method 200 for testing applications according to some embodiments of the present disclosure;

FIG. 3 illustrates a schematic diagram of an example method 300 for testing applications according to some embodiments of the present disclosure

FIG. 4 illustrates a schematic diagram of an example of the state conversion digraph for testing applications according to some embodiments of the present disclosure;

FIG. 5 illustrates a schematic diagram of an example of a system framework for testing applications according to some embodiments of the present disclosure;

FIG. 6 illustrates a schematic block diagram of an apparatus 600 for testing applications according to some embodiments of the present disclosure;

FIG. 7 illustrates a schematic block diagram of an apparatus 700 for testing applications according to some embodiments of the present disclosure;

FIG. 8 illustrates a schematic block diagram of an example device adapted to implement a plurality of embodiments of the present disclosure.

In each drawing, same or corresponding reference sign indicates the same or corresponding component.

### DETAILED DESCRIPTION OF EMBODIMENTS

It is to be understood that data involved in the technical solutions of the present disclosure, including but not limited to data per se, and acquisition or use of the data, should follow requirements of corresponding laws, regulations and rules.

It is to be appreciated that prior to the use of the technical solutions disclosed by various embodiments of the present disclosure, type, usage scope and application scenario of personal information involved in the present disclosure are made known to users through suitable ways in accordance with the relevant laws and regulations, to obtain user authorization.

For example, in response to receiving an active request from the users, a prompt message is sent to the users to clearly inform them that the operation requested to be executed needs to obtain and use their personal information. Accordingly, the users may voluntarily select, in accordance with the prompt message, whether to provide their personal information to software or hardware that performs operations of the technical solution, such as electronic device, application program, server or storage medium.

As an optional and non-restrictive implementation, in response to receiving an active request from the users, a prompt message is sent to the users, wherein the prompt message may be present in the form of pop-up window as an example and the prompt message may be displayed in text in the pop-up window. Besides, the pop-up window also may be provided with a select control through which the users may choose to “agree” or “disagree” the provision of personal information to the electronic device.

It should be appreciated that the above procedure for informing the users and obtaining the user authorization is only exemplary and does not restrict the implementations of the present disclosure. Other methods may also be applied to the implementations of the present disclosure as long as they comply with relevant regulations and laws.

Embodiments of the present disclosure will be described below in more details with reference to the drawings. Although the drawings illustrate some embodiments of the present disclosure, it should be appreciated that the present disclosure can be implemented in various manners and should not be limited to the embodiments explained herein. On the contrary, the embodiments are provided for a more thorough and complete understanding of the present disclosure. It is to be understood that the drawings and the embodiments of the present disclosure are provided merely for the exemplary purpose, rather than restricting the protection scope of the present disclosure.

In the description of the embodiments of the present disclosure, the term “includes” and its variants are to be read as open-ended terms that mean “includes, but is not limited to”. The term “based on” is to be read as “based at least in part on”. The term “one embodiment” or “this embodiment” is to be read as “at least one example embodiment”. The terms “first”. “second” and so on can refer to same or different objects. The following text also may include other explicit and implicit definitions.

There are still many problems to be addressed during software development. Current common software development mode usually depends on related technical documents. It takes a large amount of time for the development staff to read the related technical documents. Meanwhile, the development staff should also comprehend the contents in the documents to ensure that the contents are understood correctly. This development mode is relatively low efficient.

With the development of the application test techniques, the drafting manner and the contents of the technical documents of the application have been optimized. However, the application development involves front-end developers, back-end developers and test staff and their understanding of the technical document may be different and further lead to difficulty in communications and understanding during the test procedure. As a result, the test progress is stalled and the test efficiency is low.

For example, it is required to test the application both in debugging and test phases. During application test, when it is required to test the application, the front-end and back-end developers and/or test staff may jointly perform the test and the debugging. Sometimes, it is required to rewrite test codes to overcome test failure. This may waste a large amount of time and lead to low efficient application test.

To at least solve the above and other potential problems, embodiments of the present disclosure provide a method for testing applications. In this method, a terminal may first send to a server a first state of an application running on the server, wherein the first state is a state related to an interface of the application. Since the first state is sent to the server, the terminal may then receive from the server a target conversion command, wherein the target conversion command is determined in accordance with a state conversion digraph for the application and the state conversion digraph includes a set of states related to the interface of the application and a set of operation sequences for implementing state conversion. In the end, the computing device generates a second state of the application in accordance with the first state and the target conversion command to implement application test. According to this method, the state is automatically transformed by the target conversion instruction generated from the state conversion digraph, to improve the efficiency for debugging and testing the application, accelerate the speed of application development and enhance the user experience.

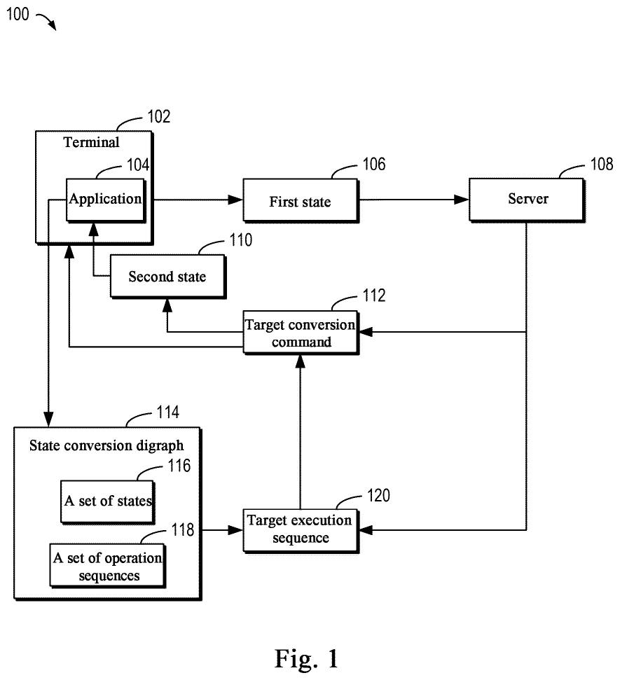

Embodiments of the present disclosure are to be described in details below with reference to the drawings. Among others. FIG. 1 illustrates an example environment in which the device and/or method of the embodiments of the present disclosure may be implemented. In the environment 100, the terminal 102 first sends to the server 108 a first state 106 of an application 104 running on the server, wherein the first state 106 is a state related to an interface presenting on the application. After sending the first state to the server 108, the terminal 102 may then receive from the server 108 a target conversion command 112, wherein the target conversion command 112 is determined by the server 108 in accordance with a state conversion digraph 114 for the application 104 and the state conversion digraph includes a set of states 116 related to the interface of the application 104 and a set of operation sequences 118 for implementing state conversion. The set of states 116 include a first state 106 and a second state 110. Then, the terminal 102 may execute an operation in the target conversion command on the interface presenting the first state, so as to generate a second state of the application 104 and implement application tests.

Examples of the terminal 102 include, but not limited to, mobile phone (such as smartphone), laptop computer. Portable Digital Assistant (PDA), electronic book (e-book) reader, portable game machine, portable media player, game machine. Set Top Box (STB), smart television (TV), personal computer, laptop computer, onboard computer (e.g., navigation unit) and the like.

Examples of the server 108 include, but not limited to, personal computer, server computer, multi-processor system, minicomputer, main frame computer and a distributed computing environment including any of the above systems or devices etc.

As shown in FIG. 1, the terminal 102 may first send to the server 108 a first state 106 of an application 104 running on the server 102, wherein the first state 106 is a state related to an interface of the application 102. The terminal 102 may collect interface identifications of the interfaces in the application and some parameters of the interfaces to generate a state of the interface. In one example, the parameters may be contents input into different text boxes or state of a button etc. After the terminal 102 sends the first state 106, the server 108 receives the first state 106.

In some embodiments, the interface identification of the interface in the application 102 is a uniform resource locator. The interface identification of the interface and the parameters in the interface will change as the uniform resource locator of the interface varies. For example, in case that an address of the uniform resource locator changes, the interface identification and the interface parameters for the interface of the application would also alter. In some embodiments, the user operation also may change parameters in the interface. For example, when an input operation is performed on a certain control in the interface, parameters corresponding to the control would change. For example, inputting the user name and the password in a registration interface will cause the parameters of the interface to change.

In some embodiments, when the interface of the application changes, the state of the application would also vary. For example, the current interface corresponds to the first state of the application; when the interface changes or the parameters change, the application will change into other states from the first state.

After the first state 106 is sent by the terminal 102, the target conversion command 112 may be received from the server 108. The target conversion command 112 is determined by the server according to the state conversion digraph 114. Besides, the server 108 also may determine from the state conversion digraph 114 a target execution sequence 120 for the tested application 104.

In some embodiments, the state conversion digraph 114 includes a set of states 116 and a set of operation sequences 118. The set of states 116 may include a plurality of states, such as first state 106 and second state 110. Alternatively, the set of states 116 also include a virtual state for a network request.

In some embodiments, the set of operation sequences may include one or more operation sequences, wherein each operation sequence in the set of operation sequences may include at least one operation. Each operation sequence may be used to realize the conversion between two states.

In some embodiments, the server 108 first determines the target execution sequence. For example, the server 108 obtains the target execution sequence from the state conversion digraph by receiving from the terminal the target state to be tested by the user; or during the test phase, one execution sequence is selected from a set of execution sequences generated from the state conversion digraph 114 as the target execution sequence. Afterwards, the server 108 further determines the operation sequence for the interface in the terminal 102 using the first state in combination with the target execution sequence and then generates the target conversion command based on the operation sequence. The server 108 sends the target conversion command 112 to the terminal 102 to implement further test.

After receiving the target conversion command 112, the terminal 102 further generates the second state 110 of the application 104 based on the first state 106 and the target conversion command 112. Afterwards, the second state 110 is reported to the server 108. Until the state conversion in the target execution sequence are executed, the test of the application is implemented.

In some embodiments, the conversion of the second state is resulted from performing the operation sequence in the target conversion command 112 on the interface in the first state.

In some embodiments, when the interface in the application is converted to the second state from the first state, the interface identification and the set of parameters originally for the first state would change. For instance, a new interface identification and/or a set of new parameters are generated.

In some embodiments, the second state may indicate a virtual state for the network request. The virtual state may obtain different processing states for the network request. In one example, when the network request passes, the second state is further converted to a state of the interface that can be operated later. In another example, when the network request fails, it is converted to a state of the interface where network request fails. Alternatively, when the network request fails, an interface prompt message indicating network request failure is sent to the application of the terminal.

FIG. 1 illustrates that the state conversion digraph 114 is arranged external to the server. This is just an example, rather than restriction of the present disclosure. The state conversion digraph 114 may be disposed inside the server 108, and also may be disposed on any suitable computing devices.

According to this method, the state is automatically transformed by the target conversion instruction generated from the state conversion digraph, to improve the efficiency for debugging and testing the application, accelerate the speed of application development and enhance the user experience.

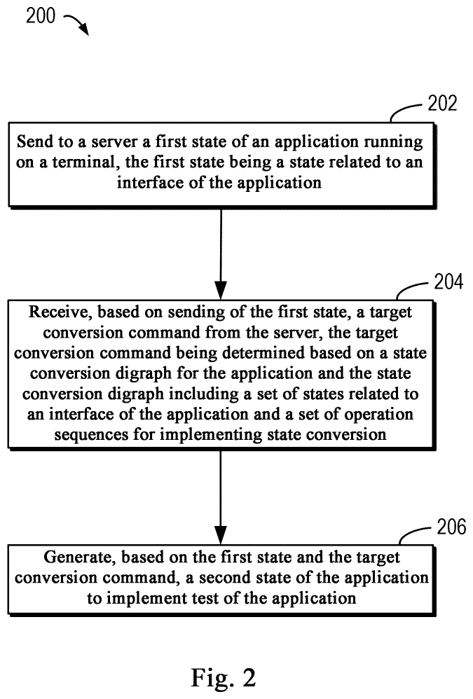

The schematic diagram of an example environment in which the device and/or method according to some embodiments of the present disclosure may be implemented has been described above with reference to FIG. 1. Next, a schematic diagram of an example method 200 for testing applications according to some embodiments of the present disclosure is to be depicted below with reference to FIG. 2. The method in FIG. 2 may be executed by the terminal 102 in FIG. 1 and/or any suitable computing devices.

As shown in FIG. 2, in the example method 200, at block 202, the first state 106 of the application 104 running on the terminal 102 is sent to the server 108, wherein the first state 106 is related to the interface of the application 104.

In some embodiments, the terminal for example is a smartphone and the application running on the terminal is a chat software. When the chat software is opened on the smartphone, the interface contains a plurality of chat frames. At this moment, the first state of the interface of the application includes interface identification and parameter information, such as information of chat frame.

In some embodiments, the terminal may receive one or more operations for the interface of the application, the one or more operations constitute an operation sequence including at least one of: a click operation, an input operation or a slide operation. The click operation indicates a click on a specified element; the input operation indicates inputting a specified value for a certain element; and the slide operation indicates sliding the specified element according to a given direction.

In some embodiments, when the user performs a click operation on the control in the interface, e.g., clicking one of a plurality of dialogue frames in the chat software, the application is converted from the original state and the converted state corresponds to the interface state after the chat frame is expanded. Then, the terminal 102 may collect the interface identification and the corresponding parameters of the interface at this time to generate the first state.

Next, at block 204, based on the sending of the first state 106, the terminal 102 receives from the server 108 the target conversion command 112. The target conversion command 112 is determined by the server 108 in accordance with the state conversion digraph 114 for the application 104 and the state conversion digraph 114 includes a set of states 116 related to the interface of the application 104 and a set of operation sequences 118 for implementing state conversion.

In some embodiments, the set of states include a plurality of states, such as first state and second state. These states both indicate the state of the interface. Additionally, the set of states also include a virtual state for the network request, which is a state associated with the interface and corresponds to a network request generated by the interface.

In some embodiments, the set of operation sequences also include a plurality of operation sequences, wherein each of the plurality of operation sequences is used for implementing conversion between the two states and the conversion among a plurality of states may be implemented by performing different operation sequences in an order.

In some embodiments, before determining the target conversion command, the server 108 is required to determine the target execution sequence. Subsequent to the determination of the target execution sequence, the server 108 also may further determine the target conversion command for the terminal using the first state in combination with the target execution sequence, to facilitate the terminal to fulfill the test of the application.

In some embodiments, when determining the target execution sequence, the server first determines the target state to be executed and then looks up the target execution sequence in the state conversion digraph according to the target state. Afterwards, the server further determines the target conversion command in combination with the first state. For example, the target conversion command is determined in accordance with the first state in the state conversion digraph, the target state and the set of operation sequences in the target execution sequence. Additionally, the state conversion digraph may include a plurality of execution sequences.

At last, at block 206, after receiving the target conversion command 112, the terminal 102 further generates the second state 110 of the application 104 based on the first state 106 and the target conversion command 112 to implement the test of the application 104. Subsequent to receiving the target conversion command 112, the terminal may perform the operation sequences in the target conversion command on the interface corresponding to the first state, so as to obtain the second state of the application. Therefore, the conversion of the second state is implemented by changing the interface identification of the first state and/or the set of parameters in the interface.

In some embodiments, when the application is converted from the first state to the second state, the interface identification and the set of parameters originally for the first state may change. For example, a new interface identification and a second set of parameters are generated.

In some embodiments, the terminal for example is a smartphone and the application running on the terminal is a chat software. When the chat software is opened on the smartphone, the interface of the first state in the application is an interface containing a plurality of chat frames.

For example, the first state indicates that the interface contains a plurality of chat frames in the chat software; and the second state indicates a virtual state of the network request asking for new information when receiving a slide-down operation for a plurality of chat frames.

After the network request in the virtual state for the second state is sent to the server, the server would return a network response to the network request. In one example, if the network response is successful, the chat software would send a new message to the application through the communications with the server. In another example, if the network response fails, the chat software would display a prompt of the network request failure on the interface of the application. In addition, the terminal may not receive Instant Message (IM).

In some embodiments, after a successful network response to the network request for the second state, if a new message for the application is determined, the application may be converted from the second state to the third state in accordance with the interface identification and the set of parameters in the interface of the application. For example, the third state indicates that a prompt mark of receiving a new message appears in the chat frame.

According to this method, the state is automatically converted by the target conversion instruction generated from the state conversion digraph, to improve the efficiency for debugging and testing the application, accelerate the speed of application development and enhance the user experience.

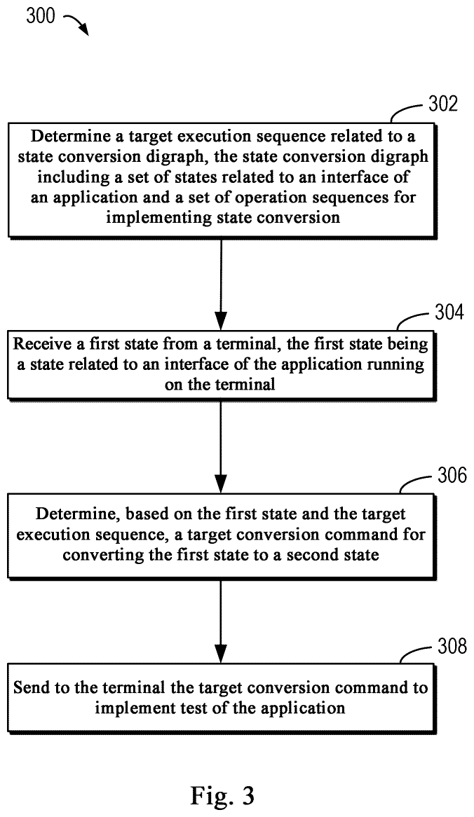

The schematic diagram of the example method 200 for testing applications in accordance with some embodiments of the present disclosure has been described above with reference to FIG. 2. Next, a schematic flowchart of an example method 300 for testing applications in accordance with some embodiments of the present disclosure is to be depicted in conjunction with FIG. 3. The example of FIG. 3 may be executed by the server 108 in FIG. 1 or any suitable computing devices.

In the example 300 shown by FIG. 3, the server 108 first determines at block 302 the target execution sequence related to the state conversion digraph, the state conversion digraph including a set of states related to the interface of the application and a set of operation sequences for implementing the state conversion.

In some embodiments, the state conversion digraph includes a set of states and a set of operation sequences. The set of states include a plurality of states and each state corresponds to one interface of the application. The set of operation sequences also include a plurality of operation sequences, wherein each of the plurality of operation sequences is used for implementing state conversion of the interface.

In some embodiments, before the determination of the target execution sequence, it is required to first determine the target state to be executed in the state conversion digraph, the target state may be the second state of the state conversion digraph and also may be the third state or other states. For example, the server 108 may receive the target state selected by the user from the terminal 102. Alternatively, the server 108 also may select one state in the state conversion digraph as the target state.

Then, after receiving the target state for the state conversion digraph, the server 108 further determines the target execution sequence according to the first state and the state conversion digraph. In one example, the link between the first state and the target state is the target execution sequence.

In some embodiments, the set of states and the set of operation sequences in the state conversion digraph may be divided to determine a plurality of execution sequences in the state conversion digraph. Upon determination of a specific test for the application, one of the plurality of execution sequences is determined as the target execution sequence.

Afterwards, at block 304, the server 108 receives the first state from the terminal 102, the first state being a state related to the interface of the application running on the terminal. The server 108 may communicate with the application on the terminal 102 to pass information, such that the server 108 may receive the state information uploaded by the terminal 102.

Next, at block 306, the server 108 determines the target conversion command for converting the first state to the second state based on the first state and the target execution sequence. After obtaining the first state, the server 108 may further determine the target conversion command in combination with the target execution sequence.

The server 108 may look up the first state in the target execution sequence and further determine from the target execution sequence the operation sequence to be executed after the first state. Additionally, the server also may further determine the second state after the first state. The operation sequence is a series of user operations, which may be one or more of the click operation, the input operation or the slide operation.

In the end, at block 308, the server 108 sends to the terminal 102 the target conversion command to implement the test of the application. After obtaining the target conversion command available for the terminal, the server 108 sends it to the terminal 102 to execute the target execution sequence in the target conversion command.

In some embodiments, the server 108 also may further receive the second state from the terminal 102. If the second state indicates the virtual state for the network request, the network response from the virtual state to the third state may be determined in accordance with the target execution sequence. The network response to the network request may be set in the state conversion digraph. For example, “network response x” is set as returning network response data to one network request. A 3-tuple (s-x, request, response) may be defined to indicate returning a response to a request initiated under the s-x state of the interface. “Network timeout response” may also be set as a special network response. A 3-tuple (s-x, request, timeout response) may be defined to indicate returning a timeout response to the request initiated under the s-x state of the interface.

In some embodiments, if the conversion from the second state to the fourth state is implemented by a network message, the network message is sent to the terminal. For example, “IM message x” indicates that one IM message is received under a state, which defined as 2-tuple (s-x, message).

According to this method, the state is automatically converted by the target conversion instruction generated from the state conversion digraph, to improve the efficiency for debugging and testing the application, accelerate the speed of application development and enhance the user experience.

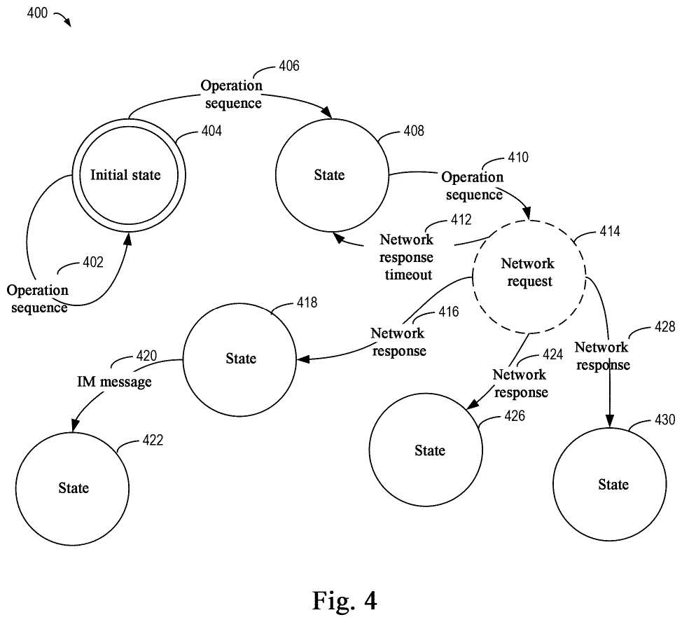

The schematic diagram of the example method 300 for testing applications in accordance with some embodiments of the present disclosure has been described above with reference to FIG. 3. Next, a schematic diagram of an example of the state conversion digraph for testing applications in accordance with some embodiments of the present disclosure is to be depicted in conjunction with FIG. 4.

In the example 400, the state conversion digraph consists of an operation sequence 402, an initial state 404, an operation sequence 406, a state 408, an operation sequence 410, a network response timeout 412, a network request 414, a network response 416, a state 418, an IM message 420, a state 422, a network response 424, a state 426, a network response 428 and a state 430.

In some embodiments, when testing the application, the application is first opened. The application, when opened, goes into the initial state 404 by default. The “initial state”, as a special state, refers to an interface state in which the application can be directly opened via a uniform resource locator and is one of the entrances to the entire digraph. Its property is uniform resource locator (URL), which may be defined as a 1-tuple s-s (URL).

“State x” refers to a certain state of the mobile software. The state may be defined as a multi-tuple of an interface URL and a series of parameters. Each variable in the tuple represents the property of one state, defined as s-x (URL, X1, X2, . . . , Xn), wherein X1, X2, . . . , Xn indicates different parameters.

Besides, the user may voluntarily configure the default state of the application when opened in the test procedure. For example, the default state of the application when opened is set to state 408. The above is an example of the present application, rather than a restriction.

In the state conversion digraph, if the operation sequence 402 is executed in the initial state 404, return to the initial state 404. If the operation sequence 406 is executed in the initial state, go into the next state 408. If the operation sequence 410 is executed in the state 408, the network request 414 may be generated. At this moment, the network request 414 is considered as the virtual state. “Network request”, as a virtual state, represents a state in which a request is initiated from one state, rather than a terminal state. Depending on the response result, it can be converted into different states. As such, it may be defined as the virtual state, which may be represented as a 2-tuple consisting of initiating state and network request. Then, different network responses may be generated for the network request 414. If a network response 428 is generated, the application enters the state 430; if a network response 424 is generated, the application goes into the state 426; if a network response timeout 412 is generated, the application returns to the state 408; if a network response 416 is generated, the application goes into the state 418. At this moment, if the IM message 420 is further received, the application enters the state 422.

The terminal for example is a smartphone and the application running on the terminal is a chat software. When the chat software is opened on the smartphone, the state 408 of the application corresponds to an interface containing a plurality of chat frames.

Under the state 408, the operation sequence 410 is executed to generate the network request 414, which is a network request asking for new information after receiving a slide-down operation for a plurality of chat frames and is a virtual state. When a network request in the virtual state for the network request 414 is sent to the server, the server would return a network response 416 to the network request. In one example, the network response 416 indicates success and the application is converted into the state 418 from the network request 414 in accordance with the interface identification and the set of parameters in the interface of the application.

After a successful network response 416 to the network request 414, the state 418 would further determine whether there is the IM message 420 for the application via the server. When it is determined that there is the IM message 420 for the application, the application is converted from the state 418 to the state 422 and a mark of a corresponding new message is displayed on the application.

When the network response to the network request 414 fails, the server sends to the application the information of the network response timeout 412 for the network request 414.

State 426 and state 430 are states after the network response 424 and the network response 428 of the network request 414. The state 414 refers to entering an interface corresponding to a state 426 related to news after clicking the news interface under the state 408. In another example, the state 430 indicates entering an interface corresponding to a state 430 related to the video after clicking the video interface under the state 408.

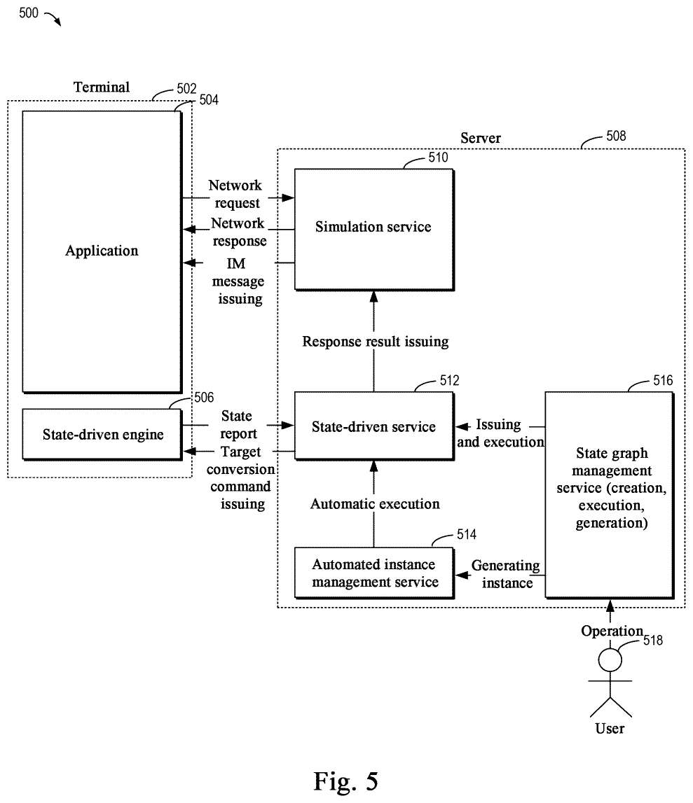

The schematic diagram of an example of the state conversion digraph for testing applications in accordance with some embodiments of the present disclosure has been described above with reference to FIG. 4. Next, a schematic diagram of an example of a system framework for testing applications in accordance with some embodiments of the present disclosure is to be depicted in conjunction with FIG. 5.

In the example 500, the system framework consists of a terminal 502, an application 504, a state-driven engine 506, a server 508, a simulation service 510, a state-driven service 512, an automated instance management service 514, a state graph management service (creation, execution, generation) 516 and a user 518.

Wherein the application 504 is used to execute commands at the terminal. For example, the application enters the initial state via the uniform resource locator and executes an operation sequence conversion instruction (s-x, (A1, A2, . . . , An)), which indicates that an operation (A1, A2, . . . , An) is executed under the state s-x. Then, the application goes into the next state. The application would also report the state. After switching the state, the new state is reported to the state-driven engine 506.

The state-driven engine 506 is an engine located inside the terminal. The state conversion digraph is executed by the state-driven engine 506 in a developed application 504. For example, when a command of entering the initial state, including the uniform resource locator, is received, a corresponding interface is opened in the terminal. When the operation sequence conversion instruction (s-x, (A1, A2, . . . , An)) is received, the operation (A1, A2, . . . , An) is executed under the state s-x. The state-driven engine 506 also may passively receive the switching report. Upon receipt of the network request, or the IM message, the mobile application will switch to a new state. In such case, the state-driven engine 506 identifies the current state and reports the current state.

The state graph management service 516 is used for creating the state conversion digraph, generating the execution sequence by processing the state conversion graph and issuing to the state-driven engine 506 to drive the execution in the mobile application. The state-driven engine 506 may also process the state conversion digraph to generate a plurality of execution sequences and send to the automated instance management service 514.

The state-driven service 512 issues the execution sequence of the state conversion digraph to the state-driven engine 506 for execution at the terminal. The state-driven service also may maintain the state conversion digraph in current execution to be prepared for the further state switching. In addition, the state-driven service 512 also may issue the return result data and the IM message data to the simulation service 510, to drive the terminal application to switch states with the simulation result. The simulation service 510 is used to return the simulation result, e.g., the network response, to drive the application of the terminal to switch states. The simulation service 510 also may issue the IM message to drive the terminal to switch states.

The automated instance management service 514 manages and executes the test instances generated via the state conversion graph.

Based on the previous example 400, the state conversion digraph is created by the user before the test development for the application. Each state corresponds to different interface states of the application. The state conversion digraph, after being created by the state graph management service 516, is issued to the state-driven service 512 for storage. Alternatively, after the user modifies the state conversion digraph, the state conversion digraph stored in the state-driven service 512 would be updated correspondingly.

Moreover, the state graph management service 516 also may generate the execution sequence during test. Then, execution instances are generated by the execution sequence and sent to the automated instance management service 514. Then, the execution instances are sent to the state-driven service 512 and automatically executed. For example, the execution sequence table is constructed according to FIG. 4.

TABLE 1
Execution Sequence Table

| Number | Execution Sequence |
|---|---|
| 1 | Initial state 404 |
| 2 | Initial state 404 (operation sequence 402) > initial state 404 |
| 3 | Initial state 404 (operation sequence 406) > state 408 |
| 4 | Initial state 404 (operation sequence 406) > state 408 |
| | (operation sequence 410) > network request 414 |
| 5 | Initial state 404 (operation sequence 406) > state 408 |
| | (operation sequence 410) > network request |
| | 414 (network response timeout 412) > state 408 |
| 6 | Initial state 404 (operation sequence 406) > state 408 |
| | (operation sequence 410) > network request |
| | 414 (network response 416) > state 408 |
| 7 | Initial state 404 (operation sequence 406) > state 408 |
| | (operation sequence 410) > network request |
| | 414 (network response 416) > state 418 |
| | (IM message 420) > state 422 |
| 8 | Initial state 404 (operation sequence 406) > state 408 |
| | (operation sequence 410) > network request |
| | 414 (network response 424) > state 426 |
| 9 | Initial state 404 (operation sequence 406) > state 408 |
| | (operation sequence 410) > network request |
| | 414 (network response 428) > state 430 |

In the test phase, the above execution sequences may be sent to the state-driven service 412 through the automated instance management service 514 and are executed through interactions with the state-driven engine 506.

For example, for sequence 1, the application enters the initial state 404. For sequence 2, the operation sequence 402 is executed in the initial state 404 to enter the initial state 404. For sequence 9, the operation sequence 406 is executed starting from the initial state 404 to enter the state 408; the operation sequence 410 is executed in the state 408 to enter a state for initiating a network request, so as to initiate the network request. Then, the application enters the state 430 in accordance with the network response 428 returned by the network.

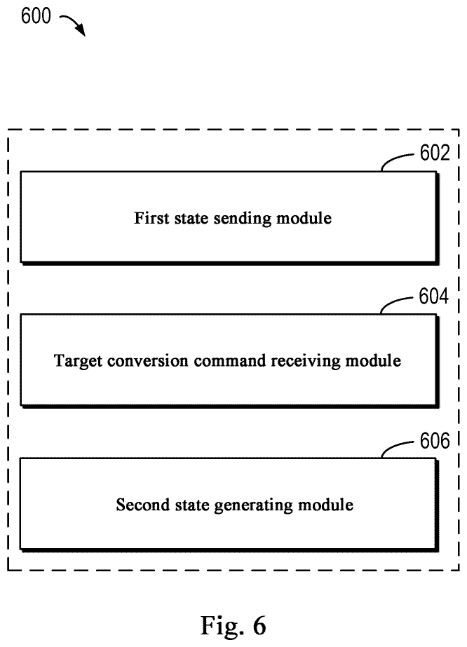

The schematic diagram of an example of a system framework for testing applications in accordance with some embodiments of the present disclosure has been described above with reference to FIG. 5. Next, a schematic block diagram of an apparatus 600 for testing applications in accordance with some embodiments of the present disclosure is to be depicted below in conjunction with FIG. 6.

As shown in FIG. 6, the apparatus 600 comprises a first state sending module 602, configured to send to a server a first state of an application running on a terminal, the first state being a state related to an interface of the application; a target conversion command receiving module 604, configured to receive from the server a target conversion command based on sending of the first state, the target conversion command being determined based on a state conversion digraph for the application and the state conversion digraph including a set of states related to an interface of the application and a set of operation sequences for implementing state conversion; and a second state generating module 606, configured to generate, based on the first state and the target conversion command, a second state of the application to implement test of the application.

In some embodiments, the target conversion command includes a target operation sequence from the set of operation sequences and the second state generating module 606 includes: an interface determining module, configured to determine the interface corresponding to the first state; a target operation sequence executing module, configured to execute the target operation sequence on the interface; and a second state generating module, configured to generate the second state in response to the target operation sequence being executed.

In some embodiments, the second state generating module includes: a set of parameters generating module, configured to generate a set of parameters of the interface in response to the target operation sequence being executed; and a second state generating module, configured to generate the second state based on an interface identification and the set of parameters of the interface.

In some embodiments, the second state generating module includes: a second set of parameters and network request generating module, configured to generate a second set of parameters and a network request of the interface in response to the target operation sequence being executed; and a second state generating module, configured to generate the second state based on an interface identification, the set of parameters and the network request of the interface, the second state indicating a virtual state for a network request.

In some embodiments, the second state generating module includes: a second state sending module, configured to send to the server the second state including the network request; and a network response receiving module, configured to receive from the server a network response to the network request.

In some embodiments, the interface identification is a uniform resource locator.

In some embodiments, the second state generating module includes: a second state sending module, configured to send to a server the second state of the application; and a network message receiving module, configured to receive a network message from the server based on sending of the second state.

In some embodiments, the apparatus 600 also comprises: a target state determining module, configured to determine a target state to be tested of the application; and a target state sending module, configured to send to the server the target state; and the target conversion command is determined based on the first state, the target state and the state conversion digraph.

In some embodiments, the target operation sequence includes at least one of: click operation, input operation or slide operation.

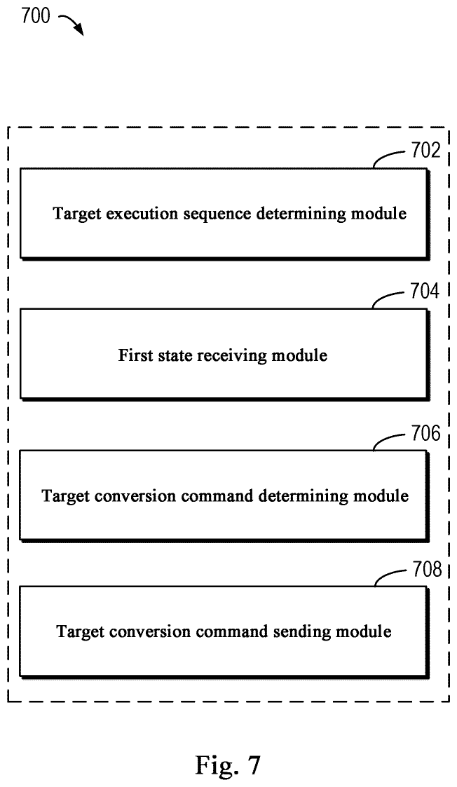

The schematic block diagram of an apparatus 600 for testing applications in accordance with some embodiments of the present disclosure has been described above with reference to FIG. 6. Next, a schematic block diagram of an apparatus 700 for testing applications in accordance with some embodiments of the present disclosure is to be depicted below in conjunction with FIG. 7.

As shown in FIG. 7, the apparatus 700 comprises a target execution sequence determining module 702, configured to determine a target execution sequence related to a state conversion digraph, the state conversion digraph including a set of states related to an interface of an application and a set of operation sequences for implementing state conversion; a first state receiving module 704, configured to receive a first state from a terminal, the first state being a state related to an interface of the application running on the terminal; a target conversion command determining module 706, configured to determine, based on the first state and the target execution sequence, a target conversion command for converting the first state to a second state; and a target conversion command sending module 708, configured to send to the terminal the target conversion command to implement test of the application.

In some embodiments, the target conversion command determining module 706 includes: a second state determining module, configured to determine, based on the target execution sequence and the first state, the second state; and a target conversion command determining module, configured to determine, based on the target execution sequence, the target conversion command for converting from the first state to the second state.

In some embodiments, the second state determining module includes: a next state adjacent to the first state determining module, configured to determine, based on the target execution sequence and the first state, a next state of the target execution sequence adjacent to the first state; and a second state determining module, configured to determine the next state as the second state.

In some embodiments, the target execution sequence determining module 702 includes: a target state receiving module, configured to receive from the terminal a target state to be tested of the application; and a target execution sequence determining module, configured to determine, based on the target state and the state conversion digraph, the target execution sequence for implementing the target state.

In some embodiments, the target execution sequence determining module 702 includes: a plurality of execution sequences generating module, configured to generate a plurality of execution sequences based on the state conversion digraph; and a target execution sequence selecting module, configured to select one execution sequence from the plurality of execution sequences as the target execution sequence.

In some embodiments, the apparatus 700 also comprises: a second state receiving module, configured to receive the second state from the terminal; a network response determining module, configured to, in response to the second state indicating a virtual state for a network request, determine a network response from the virtual state to a third state based on the target execution sequence; and a network response sending module, configured to send to the terminal the network response.

In some embodiments, the apparatus 700 further comprises: a network message sending module, configured to, in response to a conversion from the second state to a fourth state being implemented by a network message, send the network message to the terminal.

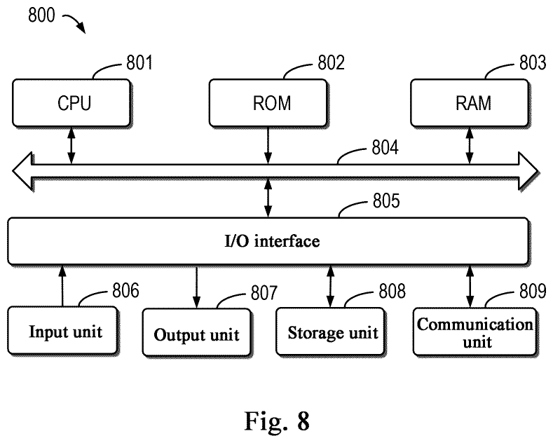

FIG. 8 illustrates a schematic block diagram of an example device 800 for implementing embodiments of the present disclosure. The terminal 102 and/or the server 108 in FIG. 1 may be implemented by the device 800. As shown in FIG. 8, the device 800 comprises a central process unit (CPU) 801, which can execute various suitable actions and processing based on the computer program instructions stored in the read-only memory (ROM) 802 or computer program instructions loaded in the random-access memory (RAM) 803 from the storage unit 808. The RAM 803 can also store all kinds of programs and data required by the operation of the device 800, CPU 801, ROM 802 and RAM 803 are connected to each other via a bus 804. The input/output (I/O) interface 805 is also connected to the bus 804.

A plurality of components in the device 800 is connected to the I/O interface 805, including: an input unit 806, such as keyboard, mouse and the like; an output unit 807, e.g., various kinds of display and loudspeakers etc.; a storage unit 808, such as disk and optical disk etc.; and a communication unit 809, such as network card, modem, wireless transceiver and the like. The communication unit 809 allows the device 800 to exchange information/data with other devices via the computer network, such as Internet, and/or various telecommunication networks.

The above described procedure and processing, such as example methods 200 and 300 and examples 400 and 500, can be executed by the processing unit 801. For example, in some embodiments, example methods 200 and 300 and examples 400 and 500 can be implemented as a computer software program tangibly included in the machine-readable medium. e.g., storage unit 808. In some embodiments, the computer program can be partially or fully loaded and/or mounted to the apparatus 800 via ROM 802 and/or communication unit 809. When the computer program is loaded to RAM 803 and executed by the CPU 801, one or more actions of the above described example methods 200 and 300 and examples 400 and 500 can be implemented.

The present disclosure can be method, apparatus, system and/or computer program product. The computer program product can include a computer-readable storage medium, on which the computer-readable program instructions for executing various aspects of the present disclosure are loaded.

The computer-readable storage medium can be a tangible apparatus that maintains and stores instructions utilized by the instruction executing apparatuses. The computer-readable storage medium can be, but not limited to, such as electrical storage device, magnetic storage device, optical storage device, electromagnetic storage device, semiconductor storage device or any appropriate combinations of the above. More concrete examples of the computer-readable storage medium (non-exhaustive list) include: portable computer disk, hard disk, random-access memory (RAM), read-only memory (ROM), erasable programmable read-only memory (EPROM or flash), static random-access memory (SRAM), portable compact disk read-only memory (CD-ROM), digital versatile disk (DVD), memory stick, floppy disk, mechanical coding devices, punched card stored with instructions thereon, or a projection in a slot, and any appropriate combinations of the above. The computer-readable storage medium utilized here is not interpreted as transient signals per se, such as radio waves or freely propagated electromagnetic waves, electromagnetic waves propagated via waveguide or other transmission media (such as optical pulses via fiber-optic cables), or electric signals propagated via electric wires.

The described computer-readable program instruction can be downloaded from the computer-readable storage medium to each computing/processing device, or to an external computer or external storage via Internet, local area network, wide area network and/or wireless network. The network can comprise copper-transmitted cable, optical fiber transmission, wireless transmission, router, firewall, switch, network gate computer and/or edge server. The network adapter card or network interface in each computing/processing device receives computer-readable program instructions from the network and forwards the computer-readable program instructions for storage in the computer-readable storage medium of each computing/processing device.

The computer program instructions for executing operations of the present disclosure can be assembly instructions, instructions of instruction set architecture (ISA), machine instructions, machine-related instructions, microcodes, firmware instructions, state setting data, or source codes or target codes written in any combinations of one or more programming languages, wherein the programming languages comprise object-oriented programming languages, e.g., Smalltalk, C++ and so on, and traditional procedural programming languages, such as “C” language or similar programming languages. The computer-readable program instructions can be implemented fully on the user computer, partially on the user computer, as an independent software package, partially on the user computer and partially on the remote computer, or completely on the remote computer or server. In the case where remote computer is involved, the remote computer can be connected to the user computer via any type of networks, including local area network (LAN) and wide area network (WAN), or to the external computer (e.g., connected via Internet using the Internet service provider). In some embodiments, state information of the computer-readable program instructions is used to customize an electronic circuit, e.g., programmable logic circuit, field programmable gate array (FPGA) or programmable logic array (PLA). The electronic circuit can execute computer-readable program instructions to implement various aspects of the present disclosure.

Various aspects of the present disclosure are described here with reference to flow chart and/or block diagram of method, apparatus (system) and computer program products according to embodiments of the present disclosure. It should be understood that each block of the flow chart and/or block diagram and the combination of various blocks in the flow chart and/or block diagram can be implemented by computer-readable program instructions.

The computer-readable program instructions can be provided to the processing unit of general-purpose computer, dedicated computer or other programmable data processing apparatuses to manufacture a machine, such that the instructions that, when executed by the processing unit of the computer or other programmable data processing apparatuses, generate an apparatus for implementing functions/actions stipulated in one or more blocks in the flow chart and/or block diagram. The computer-readable program instructions can also be stored in the computer-readable storage medium and cause the computer, programmable data processing apparatus and/or other devices to work in a particular manner, such that the computer-readable medium stored with instructions comprises an article of manufacture, including instructions for implementing various aspects of the functions/actions stipulated in one or more blocks of the flow chart and/or block diagram.

The computer-readable program instructions can also be loaded into computer, other programmable data processing apparatuses or other devices, so as to execute a series of operation steps on the computer, other programmable data processing apparatuses or other devices to generate a computer-implemented procedure. Therefore, the instructions executed on the computer, other programmable data processing apparatuses or other devices implement functions/actions stipulated in one or more blocks of the flow chart and/or block diagram.

The flow chart and block diagram in the drawings illustrate system architecture, functions and operations that may be implemented by system, method and computer program product according to multiple implementations of the present disclosure. In this regard, each block in the flow chart or block diagram can represent a module, a part of program segment or code, wherein the module and the part of program segment or code include one or more executable instructions for performing stipulated logic functions. In some alternative implementations, it should be noted that the functions indicated in the block can also take place in an order different from the one indicated in the drawings. For example, two successive blocks can be in fact executed in parallel or sometimes in a reverse order dependent on the involved functions. It should also be noted that each block in the block diagram and/or flow chart and combinations of the blocks in the block diagram and/or flow chart can be implemented by a hardware-based system exclusive for executing stipulated functions or actions, or by a combination of dedicated hardware and computer instructions.

Various embodiments of the present disclosure have been described above and the above description is only exemplary rather than exhaustive and is not limited to the embodiments of the present disclosure. Many modifications and alterations, without deviating from the scope and spirit of the explained various embodiments, are obvious for those skilled in the art. The selection of terms in the text aims to best explain principles and actual applications of each embodiment and technical improvements made in the market by each embodiment, or enable those ordinary skilled in the art to understand embodiments of the present disclosure.

I/We claim:

1. A method for testing an application, comprising:
sending to a server a first state of an application running on a terminal, the first state being a state related to an interface of the application;
receiving, based on sending of the first state, a target conversion command from the server, the target conversion command being determined based on a state conversion digraph for the application and the state conversion digraph comprising a set of states related to an interface of the application and a set of operation sequences for implementing state conversion; and
generating, based on the first state and the target conversion command, a second state of the application to implement test of the application.

2. The method of claim 1, wherein the target conversion command comprises a target operation sequence from the set of operation sequences and generating, based on the first state and the target conversion command, a second state of the application to implement test of the application comprises:
determining the interface corresponding to the first state;
executing the target operation sequence on the interface; and
generating the second state in response to the target operation sequence being executed.

3. The method of claim 2, wherein generating the second state in response to the target operation sequence being executed comprises:
generating a set of parameters of the interface in response to the target operation sequence being executed; and
generating, based on an interface identification and the set of parameters of the interface, the second state.

4. The method of claim 3, wherein generating, based on an interface identification and the set of parameters of the interface, the second state comprises:
generating a second set of parameters and a network request of the interface in response to the target operation sequence being executed; and
generating, based on an interface identification, the set of parameters and the network request of the interface, the second state indicating a virtual state for a network request.

5. The method of claim 4, further comprising:
sending to the server the second state comprising the network request; and
receiving from the server a network response to the network request.

6. The method of claim 4, wherein the interface identification is a uniform resource locator.

7. The method of claim 3, further comprising:
sending to a server the second state of the application; and
receiving, based on sending of the second state, a network message from the server.

8. The method of claim 1, further comprising:
determining a target state to be tested of the application; and
sending to the server the target state; and
wherein the target conversion command is determined based on the first state, the target state and the state conversion digraph.

9. The method of claim 2, wherein the target operation sequence comprises at least one of: click operation, input operation or slide operation.

10. A method for testing an application, comprising:
determining a target execution sequence related to a state conversion digraph, the state conversion digraph comprising a set of states related to an interface of an application and a set of operation sequences for implementing state conversion;
receiving a first state from a terminal, the first state being a state related to an interface of the application running on the terminal;
determining, based on the first state and the target execution sequence, a target conversion command for converting the first state to a second state; and
sending to the terminal the target conversion command to implement test of the application.

11. The method of claim 10, wherein determining, based on the first state and the target execution sequence, a target conversion command for converting the first state to a second state comprises:
determining, based on the target execution sequence and the first state, the second state; and
determining, based on the target execution sequence, the target conversion command for transitioning the first state to the second state.

12. The method of claim 11, wherein determining, based on the target execution sequence and the first state, the second state comprises:
determining, based on the target execution sequence and the first state, a next state of the target execution sequence adjacent to the first state; and
determining the next state as the second state.

13. The method of claim 10, wherein determining a target execution sequence related to a state conversion digraph comprises:
receiving from the terminal a target state to be tested of the application; and
determining, based on the target state and the state conversion digraph, the target execution sequence for implementing the target state.

14. The method of claim 10, wherein determining a target execution sequence related to a state conversion digraph comprises:
generating, based on the state conversion digraph, a plurality of execution sequences; and
selecting one execution sequence from the plurality of execution sequences as the target execution sequence.

15. The method of claim 10, further comprising:
receiving the second state from the terminal;
in response to the second state indicating a virtual state for a network request, determining, based on the target execution sequence, a network response from the virtual state to a third state; and
sending to the terminal the network response.

16. The method of claim 15, further comprising:
in response to a conversion from the second state to a fourth state being implemented by a network message, sending the network message to the terminal.

17. An electronic device, comprising:
at least one processor; and
a memory for storing at least one program, the at least one program, when executed by the at least one processor, causing the at least one processor to:
send to a server a first state of an application running on a terminal, the first state being a state related to an interface of the application;
receive, based on sending of the first state, a target conversion command from the server, the target conversion command being determined based on a state conversion digraph for the application and the state conversion digraph comprising a set of states related to an interface of the application and a set of operation sequences for implementing state conversion; and
generate, based on the first state and the target conversion command, a second state of the application to implement test of the application.

18. The electronic device of claim 17, wherein the target conversion command comprises a target operation sequence from the set of operation sequences and the at least one program causing the at least one processor to generate, based on the first state and the target conversion command, a second state of the application to implement test of the application comprises instructions to:
determine the interface corresponding to the first state;
execute the target operation sequence on the interface; and
generate the second state in response to the target operation sequence being executed.

19. The electronic device of claim 18, wherein the at least one program causing the at least one processor to generate the second state in response to the target operation sequence being executed comprises instructions to:
generate a set of parameters of the interface in response to the target operation sequence being executed; and
generate, based on an interface identification and the set of parameters of the interface, the second state.

20. The electronic device of claim 19, wherein the at least one program causing the at least one processor to generate, based on an interface identification and the set of parameters of the interface, the second state comprises instructions to:
generate a second set of parameters and a network request of the interface in response to the target operation sequence being executed; and
generate, based on an interface identification, the set of parameters and the network request of the interface, the second state indicating a virtual state for a network request.
